(19) United States
(12) Patent Application Publication
(10) Pub. No.: US 2023/0264370 A1
(43) Pub. Date: Aug. 24, 2023

(54) ROD AND CASING HANDLER

(71) Applicant: TEI Rock Drills, Inc., Montrose, CO (US)

(72) Inventors: William N. Patterson, Montrose, CO (US); Brison Klein, Montrose, CO (US)

(73) Assignee: TEI Rock Drills, Inc., Montrose, CO (US)

(21) Appl. No.: 18/171,556

(22) Filed: Feb. 20, 2023

Related U.S. Application Data
(60) Provisional application No. 63/312,345, filed on Feb. 21, 2022.

(51) Int. Cl. B25J 15/00; B25J 9/14

(52) U.S. Cl. CPC B25J 15/0038; B25J 9/144

(57) ABSTRACT

The present disclosure is directed to systems and methods for simultaneously and concentrically handling cylindrical objects of different diameters. Also, the present disclosure is directed to a handler having a clamp that includes pairs of outer and inner tongs spaced apart on separate sides of the central plane that is orthogonal to a central longitudinal axis of the cylindrical object. Some embodiments may include a clamp having a mounting plate and a piston assembly coupled to the mounting plate where the central plane is parallel to the mounting plate. Some embodiments include a plurality of linkage bars pivotally coupled between the piston assembly and the plurality of outer tongs and inner tongs. In some embodiments, in response to a movement of the piston assembly, the inner and outer tongs pivot between an open position and a closed position to secure the cylindrical object between the inner and outer tongs.

### CROSS-REFERENCE TO RELATED PATENT APPLICATION

This patent application claims priority to U.S. Provisional Application No. 63/312,345, filed on Feb. 21, 2022, the entire disclosure of which is hereby incorporated by reference herein.

### TECHNICAL FIELD

The present disclosure relates to earth boring drilling equipment, and more particularly to a versatile excavator mounted handler for simultaneously handling rods and casings in connection with drilling operations.

### BACKGROUND

In earth boring operations, rods and casings are used to create and maintain the bore hole. Rods and casings are each cylindrical bodies that can be made of steel or other relatively sturdy metal material. Rods and casings come in certain lengths, for example, 6 and 20 feet, or in a range therebetween. Having such lengths, rods and casings can be heavy and may be heavy enough or large enough that more than one individual is required to lift a single length or segment of the rod or casing. Lifting rods and casings by hand may be dangerous and inefficient.

Rods and casings are often delivered to a job site on pallets in piles. Equipment that handles rods and casings should be able to pick the rods and casings directly from the piles. Finally, there are significant efficiencies that result when rods and casings are handled simultaneously with the rod being positioned inside the casing.

### SUMMARY

According to one aspect, there is provided a rod and casing handler having at least one clamp for handling cylindrical objects, such as pipes, rods, or drill tooling/casing. The clamp is configured to grip a range of different outer diameters and maintain substantially the same center point regardless of the diameter of the cylindrical object being clamped by utilizing a four-arm system. For example, the clamping motion is governed by two four-bar linkages. One joint of the linkage mechanism is fixed, while the two adjacent joints are free to move, and a third is driven by a hydraulic cylinder.

In some embodiments, the two inner clamping tongs are interlocking, and the interlocking tongs are staggered along a central plane of the clamp (the central plane being orthogonal to a central axis of the handled cylindrical object). To ensure no substantial moment is produced as a result of clamping the cylindrical object, the inner clamping tongs are split into two separate subsets and separated symmetrically with respect to the central plane of the clamp. Separating the clamps in this fashion ensures the resultant force of each clamp tong is in-line with the center plane of the clamp, thus allowing the clamp tongs to impart torque in every direction on the cylindrical object being grabbed. Separating the clamp tongs also provides a more spread-out and stable gripping or clamping surface, which facilitates countering a moment created by the weight of the cylindrical object being grabbed.

In some embodiments, the points of contact for the tongs are as equally spaced as possible to ensure the clamp does not bind up or stop prematurely when grabbing a cylindrical object. If the points of contact were too in-line opposite each other, the clamp would grab a cylindrical object with two points of contact, which would diminish its grip on said object. If the points of contact were too in-line with one another in the same direction, the object being grabbed would be more likely to escape from the tongs and bind up the clamp.

In another aspect, the clamp tongs maintain cylindrical concentricity throughout the entire clamping motion. If four substantially equal lines are drawn substantially orthogonal to the inside gripping surface of each clamp tong, the point where they intersect will coincide with the center of a circle contained within the tongs. The clamp preserves the center point in a substantially the same location for the entire range of clamping motion.

In some embodiments, due to self-centering nature of the clamps, it is not necessary to place the cylindrical object in a specific location inside the clamp in order to appropriately grab it. The object can be placed anywhere inside of the tongs and will be pulled in to be properly gripped by the tongs. In some embodiments, the clamps have long distal ends of the tongs. Thus, the above described pulling-in action along with long tongs provides the clamp that may more efficiently grab a single cylindrical object when, for example, such object is in a stack with other cylindrical objects.

In another aspect, the rod and casing handler may include one, two, three, four or any other number of clamps, and is designed to be attached to an excavator using an adapter plate. Having an equal number of clamps on each side may provide additional resistance to a torque imposed on the clamps when a heavy cylindrical object is grabbed off-center. There may be an unequal number of clamps disposed on different sides of a central location (the location, where the rod and casing handler is attached to the excavator). The clamps may center two or more pipes of the different diameters, thus, one may achieve a displacement of hollow cylindrical objects to be inside one another while being handled by the rod and casing handler. The rod and casing handler can be rotated around the vertical and horizontal axes to properly orient when grabbing, placing or otherwise handling the object. Rotation may be performed by one or two 17-inch dual motor slew drives.

In some embodiments, a hydraulic circuit for the clamp(s) may be disposed in a housing within a supporting structure between the two sets of clamps on the opposite sides of the central location. Each individual clamp may have its own counterbalance and accumulator to ensure a grip is maintained by each clamp despite a leak or due to other malfunctioning factors in the hydraulic system.

In some embodiments, control valves for the rod and casing handler are housed in a box that may mount the slew drives to one another. Each set of clamps may share a control valve, such that the set of clamps is synchronously closed and opened at the same time. The control valves are coupled to the accumulator circuits inside the front housing using a rotating manifold. The rotating manifold may cause rotation of the clamp arms, on which the clamps are disposed, completely continuous.

### BRIEF DESCRIPTION OF THE DRAWINGS

A more complete understanding of the present invention may be acquired by reference to the following Detailed Description when taken in conjunction with the accompanying Drawings wherein:

FIG. 1 is a perspective view of a rod and casing handler;

FIG. 2 is a perspective view of the rod and casing handler of FIG. 1;

FIG. 3 is a rear view of the rod and casing handler of FIGS. 1 and 2;

FIG. 4 is a perspective view of a clamp of the rod and casing handler of FIGS. 1 and 2;

FIG. 5 is an exploded perspective view of the clamp of FIG. 4;

FIGS. 6A and 6B are perspective and side views of the outer tongs, respectively;

FIGS. 6C and 6D are perspective and side views of the inner tongs, respectively;

FIG. 7 is a fragmented section view of the clamp of FIGS. 4 and 5;

FIGS. 8A - 8J are side views of the clamp of FIGS. 4 and 5 at varying clamping positions;

FIGS. 9A and 9B are side views of the clamp of FIGS. 4, 5, and 7 clamping different diameters of cylindrical objects; and

FIG. 10 is a side view of the rod and casing handler.

### DETAILED DESCRIPTION

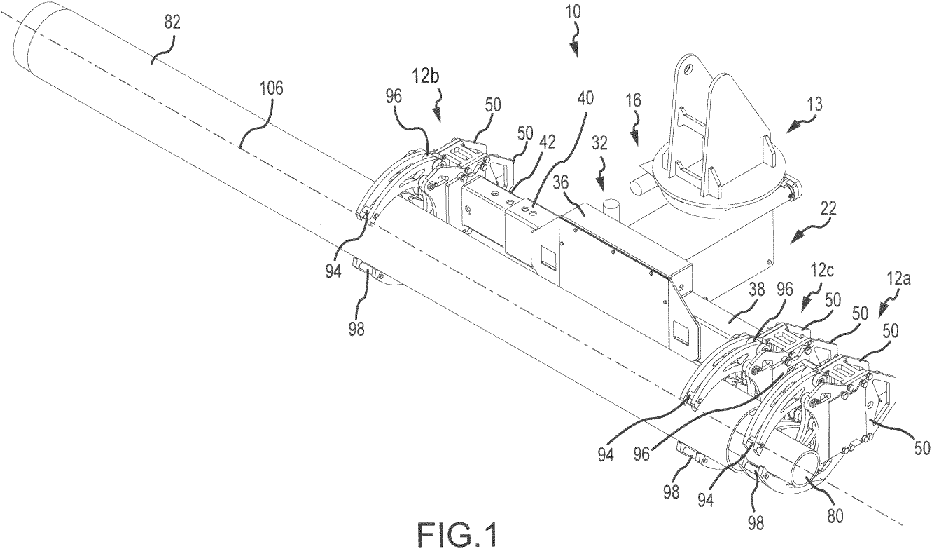

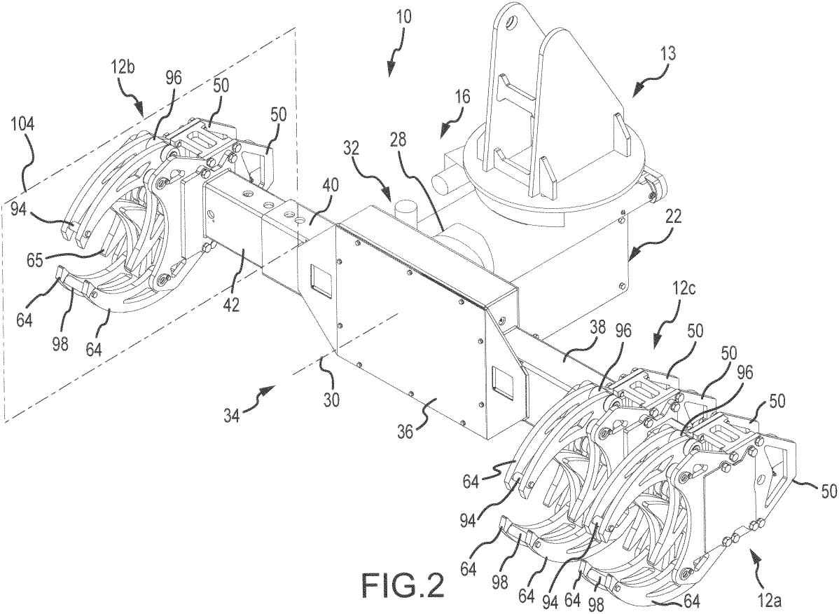

FIGS. 1 and 2 illustrate a rod and casing handler 10, which may also be referred to as a rod and casing manipulator, in which a plurality of actuatable clamps 12 are employed to advantage to lift and manipulate casings, rods, and other cylindrical objects. While FIGS. 1 and 2 illustrate the cylindrical objects, it should be understood that other profiles can be handled by the rod and casing handler 10, such as, for example, triangle, square, octagonal, rectangle, or any other shape. In the embodiment illustrated in FIGS. 1 and 2, the rod and casing handler 10 is removably coupled to an excavator or other type of equipment (not illustrated) to actuate the clamps 12. For example, according to some embodiments, the casing handler 10 is coupled to a hydraulic system of the excavator to actuate the clamps 12, and in particular and as discussed in greater detail below, to actuate a plurality of tongs 64 and 65 associated with each of the clamps 12. It should be understood, however, that methods other than hydraulic actuation may be used. As illustrated in FIGS. 1 and 2, the rod and casing handler 10 includes the clamps 12 disposed on a first arm 38 and on an adjustable clamp mounting arm 42 telescopingly extendable from a second arm 40; although, it should be understood that a greater or fewer number of clamps 12 may be employed.

As illustrated in FIGS. 1 and 2, the rod and casing handler 10 includes an excavator mount 13 configured to be grasped and secured to the excavator or other type of construction or drilling equipment with a hydraulic system and boom. The excavator mount 13 is secured to a handler positioner 16 that facilitates rotation with respect to the excavator mount 13. A control box 22 is secured to the handler positioner 16. The control box 22 houses the hydraulic and/or electrical components that allow the rod and casing handler 10 to be positioned and/or the clamps 12 to be actuated.

According to one embodiment, an arm positioner 28 includes a motor 32 and a worm drive gear arrangement. The components housed in the control box 22, the handler positioner 16 and the arm positioner 28 may be controlled by wired and/or wireless communication with a joystick, that can be, for example, in a cabin of the excavator.

In FIGS. 1 and 2, a clamp mount assembly 34 is coupled to the arm positioner 28 opposite the control box 22. The clamp mount assembly 34 includes a central portion 36, the first arm 38 extending in a first direction from the central portion 36, and the second arm 40 extending in an opposite direction from the central portion 36. The central portion 36 houses hoses, valves, and other components of the hydraulic system for actuation of the clamps 12. According to one embodiment, a rotating manifold 132 fluidly couples hydraulic fluid conduits exiting the control box 22 and entering the central portion 36 of the clamp mount assembly 34. The rotating manifold 132 is disposed along the axis 30, as best shown in FIG. 2, and enables the clamp mount assembly 34 to rotate over 360 degrees with respect to the control box 22 without twisting the hydraulic lines. In addition, the rotating manifold 132 can also include an electrical section that provides electrical wires a passageway through the junction of the control box 22 and the clamp mount assembly 34, which rotates with respect to the control box 22.

In some embodiments, the rod and casing handler 10 may have one or more 17-inch dual motor slew drives. Such slew drives may be coupled to each other via the control box 22. The rotating manifold 132 allows a completely continuous rotation, for example, over 360-degree rotation, of the rod and casing handler 10 to properly orient the clamps 12 when grabbing or otherwise handling an object. The ability to rotate beyond 360 degrees and maintain electrical and/or hydraulic connections without twisting them allows an operator to efficiently rotate the clamp mount assembly 34 and the clamps 12 to any desired position from any starting position and to use the most direct rotational motion to arrive at the desired position.

With continued reference to FIGS. 1 and 2, the first arm 38 is an elongated member connected on one end to and extending from the central portion 36 for supporting at an opposite end at least one clamp 12. In operation, the clamps 12 grab and otherwise support heavy cylindrical bodies such as rods, pipes, casings, and the like, which are commonly used in drilling operations. According to embodiments disclosed herein, the rod and casing handler 10 actuates to clamp, handle and/or manipulate a larger diameter casing and a smaller diameter rod simultaneously and/or concentrically. Typically, the rod, that can be either a hollow pipe or solid, is inserted within the casing such that a portion of the rod extends from the casing, as illustrated, for example, in FIG. 1. In one embodiment, a first end clamp 12a is disposed at a distal end of a first arm 38 and grasps a portion of the smaller diameter pipe or rod extending outside of the casing. A second end clamp 12b is disposed at a distal end of the adjustable clamp mounting arm 42, which is coupled to and extends from the second arm 40 in order to grasp the casing. The first end clamp 12a may be independently actuated from the second end clamp 12b. In this manner, rod and casing may be simultaneously handled, which simplifies inserting rods and casings and other cylindrical bodies into a drilled hole or removing rods and casings and other cylindrical bodies from a drilled hole.

As illustrated in FIGS. 1 and 2, for example, the rod and casing handler 10 may have more than one clamp 12 on one or both arms 38 and 40. For example, the first arm 38 may have a second clamp 12c (i.e., in addition to 12a) that may be actuated synchronously with the second end clamp 12b in such a manner that both second end clamp 12b and the additional first end clamp 12c are configured to handle the casing (for example, a relatively larger diameter pipe).

In some embodiments, the second arm 40, that includes the adjustable clamp mounting arm 42, may have one or more additional clamps 12 (in addition to 12 b). In operation, the clamps 12 disposed on the first arm 38 may be actuated synchronously with each other, but independently from the clamp(s) 12 disposed at the adjustable clamp mounting arm 42 on the second arm 40. Such embodiment allows clamps 12 disposed at the first arm 38 to handle pipe of a different diameter than the pipe handled by the clamps 12 disposed at the adjustable clamp mounting arm 42. Having a number of clamps 12 disposed at the first arm 38 being equal to the number of clamps 12 disposed at the adjustable clamp mounting arm 42 provides resistance to a torque exerted on the clamps when a cylindrical object is engaged by the clamps 12 and offset from the center of gravity of the cylindrical object.

As illustrated in the embodiment of FIGS. 1 and 2, the second arm 40 is generally hollow and configured to telescopingly receive the adjustable clamp mounting arm 42 therein. As shown in FIG. 2, the adjustable clamp mounting arm 42 can be extended a greater distance from the central portion 36, and, thus, the length of the cylindrical objects that can be handled by the rod and casing handler 10 can likewise be increased. When the distance between the first end clamp 12a and the second end clamp 12b is increased, longer cylindrical bodies can be handled or separate cylindrical bodies can be handled by separate clamps 12a, 12b without the cylindrical bodies interfering with each other. For example, in one embodiment, one of the clamps 12b may be telescoped from a minimum distance between clamps 12a, 12b of approximately 57 inches to a maximum distance between clamps 12a, 12b of 66 inches. Such configuration of the clamp mount assembly 34 allows handling of rods and casings from 57 inches to 120 inches in length.

Moreover, one or more of the clamps 12b disposed at the adjustable clamp mounting arm 42 may work synchronously with one or more of the clamps 12a, 12c disposed at the first arm 38. For example, when one or more of the clamps 12b disposed at the adjustable clamp mounting arm 42 are actuated to open or close for a certain distance between the respective outer tongs 64, then one or more clamps 12a, 12c disposed at the first arm 38 can be opened or closed for the same distance between the respective outer tongs 64 of the clamps 12a, 12c disposed at the first arm 38. Dependent and independent movement of clamps 12a, 12b, and 12c disposed at the first arm 38 and the adjustable clamp mounting arm 42 allows the rod and casing handler 10 to hold two or more different diameters of the pipes and, as described herein, to have larger and smaller diameter pipes being concentric and/or coaxial as to each other.

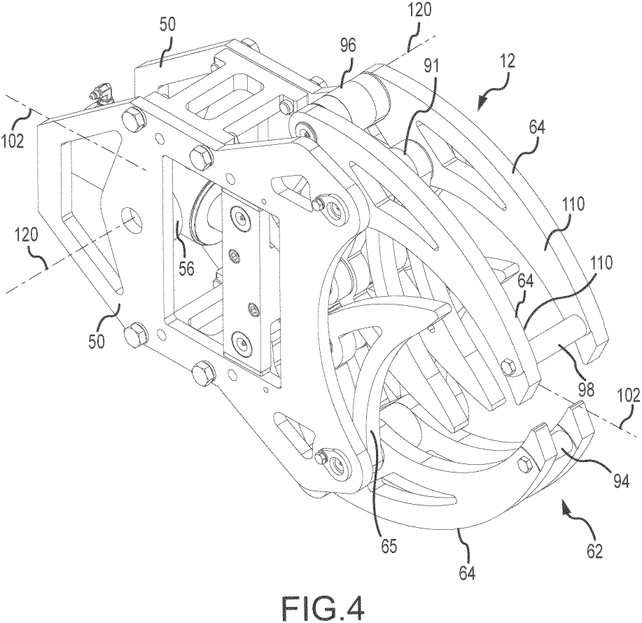

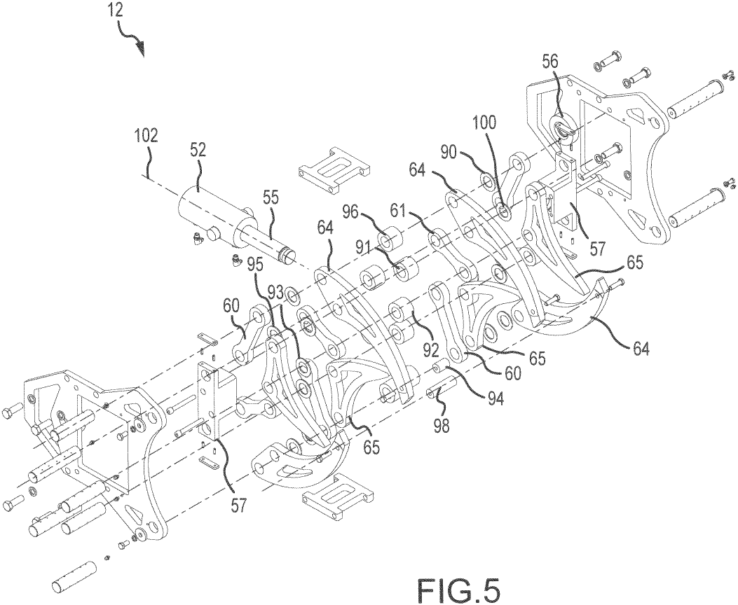

Referring now to FIGS. 4, 5 and 7, a perspective, an exploded, and a fragmented section view of the clamp 12 are illustrated. In some embodiments, the clamp 12 can generally include a mounting plate 50, a piston assembly (that may include, for example, a hydraulic cylinder 52, a movable piston 55), and the outer and inner tongs 64 and 65, respectively. For example, the mounting plate 20 is disposed on either side or both sides of the clamp 12. A pair of side support brackets 56 can be disposed on and otherwise coupled to the mounting plates 50 to support the hydraulic cylinder 52, which as explained in greater detail below, is operable to actuate the clamp 12. The hydraulic cylinder 52 includes fitting(s) 54 that enable hydraulic fluid to flow and displace the movable piston 55 extending from the hydraulic cylinder 52. In some embodiments, the piston assembly may include a pair of piston blocks 57 that is coupled to a distal end of the piston 55 to couple to and actuate the clamp 12.

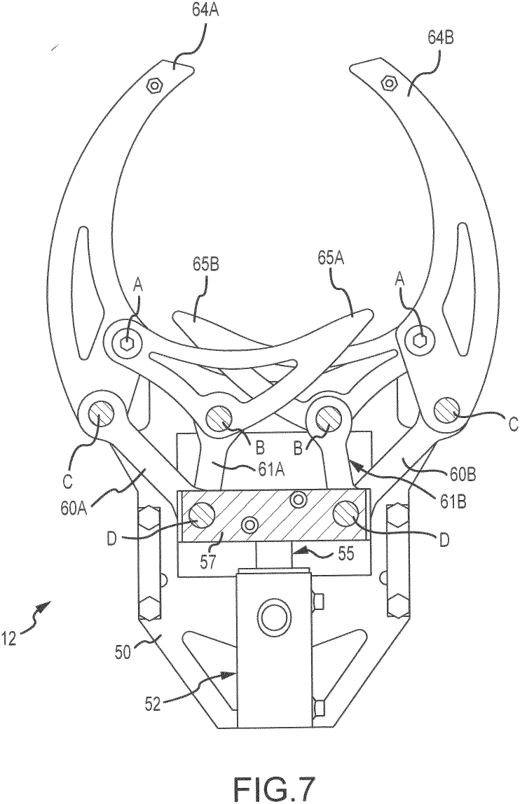

With particular reference to FIG. 7, the details of the clamp 12 are illustrated. The clamp 12 has a central plane 104 (FIG. 2), which is orthogonal to a central axis 106 of the handled pipe. In some embodiments, the outer and inner tongs 64 and 65 are movable in a plane parallel to the central plane 104. In the embodiment illustrated in FIG. 7, a first outer linkage bar 60a is connected to and extends between the piston blocks 57 and a first outer tong 64a. The second outer linkage bar 60b is connected to and extends between the piston block 57 and a second outer tong 64b. A first inner linkage bar 61a is connected to a first inner tong 65a. A second inner linkage bar 61b is connected to a second inner tong 65b. Additionally, the first and second inner tongs 65a and 65b (or a pair of inner tongs) are coupled to the respective first and second outer tongs 64a and 64b (or a pair of outer tongs), respectively, along pivot axes A. In the embodiment illustrated in FIG. 7, the couplings between the outer and inner linkage bars 60, 61 and the outer and inner tongs 64, 65 utilize a pin connection or any other suitable connection to allow the relative movement and/or pivoting of linkage bars 60, 61 and outer and inner tongs 64, 65 with respect to each other in response to the displacement of the piston 55.

For example, the movement and/or pivoting of components of the clamp 12 may be guided by two four-bar linkage mechanisms described herein, wherein a joint of the each linkage mechanism denoted with letter A is fixed to the mountable plate 50, the two adj acent joints denoted with letters B and C have freedom to move in any planar direction parallel to the central plane 104 of the clamp 12, and a third joint denoted with letter D is driven by a force exerted from the motion of piston block(s) 57 that are moved by the piston 55 that is coupled to the hydraulic cylinder 52.

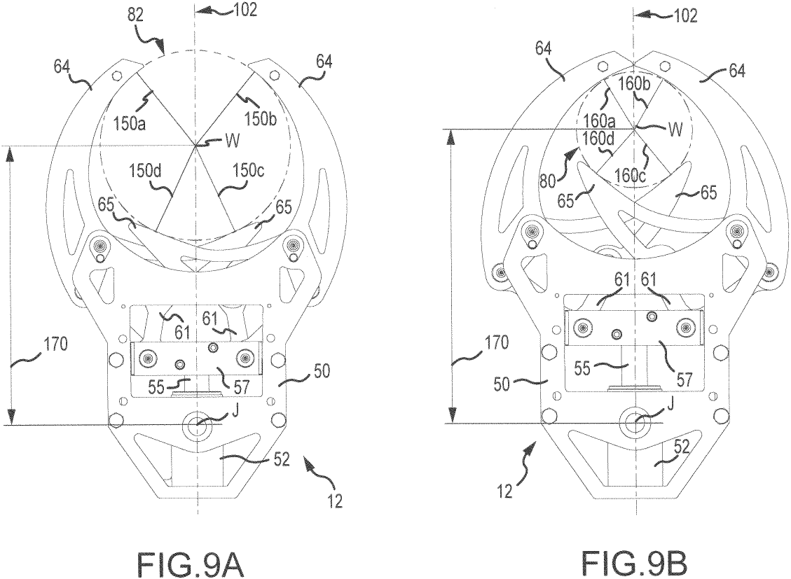

Reference is now made to FIGS. 9A and 9B that illustrate side views of the clamp 12 handling different diameters of the cylindrical objects. For example, a center point is denoted with letter W and is defined as the intersection of the lines that are parallel to the central plane 104 and orthogonal to the gripping surfaces of the tongs 64 and 65. In some embodiments, the center point W coincides or substantially coincides with the central axis 106 of the pipe held by the rod and casing handler 10. As a result of the two four-bar linkage mechanisms, the center point W remains stationary with respect to the stationary parts of the clamp 12 regardless of the outer diameter of the pipe that is surrounded by the outer and inner tongs 64 and 65. The clamp 12 is configured to have a longitudinal axis 102 (as best illustrated in FIG. 4), along and orthogonal to which the gripped pipe is moved to be surrounded by the outer and inner tongs 64 and 65. In certain embodiments disclosed herein, the longitudinal axis 102 of the clamp 12 and the longitudinal central axis 102 of the cylinder 52 are coaxial.

The connection of the first outer linkage bar 60 to the outer tong 64 is offset from a pivot point A of the outer tong 64 to create a torque such that the actuatable outer tong 64 is rotatable and/or pivotable about the pivot point A. Rotation of each of the outer tongs 64 about the pivot point A is enabled by the pair of inner linkage bars 61 that are coupled to the inner tongs 65 that are in turn coupled to the outer tongs 64 about the pivot point A. In operation, hydraulic actuation and displacement of the piston 55 within the hydraulic cylinder 52 acts on the linkage bars 60 and 61, which in turn pivot the actuatable outer and inner tongs 64 and 65 to facilitate opening and closing thereof. Each outer tong 64 may be identical and may include a portion that is configured to be positioned around a cylindrical body to be grasped, gripped or otherwise handled. In operation, the outer tongs 64 hold the cylindrical object against the inner tongs 65.

According to some embodiments, the outer and inner tongs 64 and 65 are disposed in parallel planes such that one of the first or second inner tongs 65 is in a parallel plane spaced apart from another first or second inner tong 65, respectively. To reduce or eliminate a moment on the hydraulic cylinder 52, e.g., the moment that is produced as a result of the clamping/gripping action, the inner tongs 65 are disposed in two separate parallel planes symmetrically on opposite sides of the central plane 104 of the clamp 12. In some embodiments, spacer bushings 91 and 92 may be used to separate the inner tongs 65.

In some embodiments, the outer tongs 64 are disposed in parallel planes such that one of the first or second outer tongs 64 is in a parallel plane spaced apart from another outer tong 64. To reduce or eliminate the moment on the hydraulic cylinder 52 described above, such outer tongs 64 may be disposed in the symmetrical planes parallel to and on the opposite sides of the central plane 104. In some embodiments, spacer bushings 94 and 98 may be used to separate the outer tongs 64. In some embodiments, a spacer bushing 96 may also be used to separate the outer tongs 64 and a spacer bushing 91 may be used to separate the inner and outer tongs 65 and 64.

In some embodiments, thrust bearings 90 may be disposed on at least one end of the outer tongs 64 and/or outer linkages 60 in the symmetrical planes parallel to and on the opposite sides of the central plane 104. According to some embodiments, thrust bearings 100 may be disposed on at least one end of the inner or outer tongs 65 and 64 in the symmetrical planes parallel to and on the opposite sides of the central plane 104. In some embodiments, thrust bearings 93 may be disposed on at least one end of the inner arms 63 and/or inner linkages 61 in the symmetrical planes parallel to and on the opposite sides of the central plane 104. According to some embodiments, thrust bearings 95 may be disposed on at least one end of the inner and/or outer linkages 61, 60 in the symmetrical planes parallel to and on the opposite sides of the central plane 104.

Spacer bushings 91, 92, 94, 96, and 98 may have different lengths making the spaced apart distance suitable for different applications. For example, in some embodiments such spaced apart distance between inner surfaces 110 of the outer arms 62 and the outer tongs 64 may be 5.08 cm (2 inches), in other embodiments, such distance may be 2.54 cm (1 inch) or 7.62 cm (3 inches). While these distances are described herein, it should be understood that other suitable distances can be achieved by using different sizes of the bushings 91, 92, 94, 96, 98 and various pins coupling the symmetrical outer tongs 64 as well as the symmetrical inner tongs 65. Correspondingly, the spaced apart distance between the outer tongs 64 and inner tongs 65 may also be different.

Forming such subsets of the tongs 64, 65 (that are spaced apart and substantially equidistantly separated from the central plane 104 of the clamp 12) facilitates the resultant force of each clamp tong 64, 65 to be within the center plane 104 of the clamp 12, thus allowing the clamp tong 64, 65 to impart torque in every direction on the cylindrical object that is gripped or held by the outer and inner tongs 64, 65. Such spacing apart of the inner tongs 65 also provides a more equally spread-out and stable clamping/gripping surface by the outer and inner tongs 64, 65, that, in turn, facilitates counter-balancing a moment created by the weight of the pipe disposed within the outer and inner tongs 64, 65.

This resulting cantilever mechanism having, for example, a 5.08-cm (2-inch) distance between the inner surfaces 110 of the spaced apart outer tongs 64 of the clamp 12 allows an operator to utilize only one clamp 12 to have a substantially stable gripping and/or holding one end of the casing having the length of equal or up to, for example, 4.674 meters (15 feet and 4 inches), outer diameter 19.685 cm (7.75 inches) and a weight of about 272.155 kg (600 lbs.). For example, the central axis 106 of the handled pipe remains substantially orthogonal to the central plane 104 of the clamp 12, wherein only a relatively small deviation from the pipe central axis 106 may occur on the opposite end of the pipe not held by another clamp 12. For example, handling a pipe having a cantilever 4.268 meters (14 feet) and a moment arm 2.134 meters (7 feet) and weight 272.155 kg (600 lbs.), one clamp 12 may withstand the torque of 4200 feet - lbs. Therefore, safety of holding such cantilevered pipe is also significantly improved when there is a distance (that can be, for example, 5.08 cm (2 inches)) between the inner surfaces 110 of the spaced apart outer tongs 64.

According to an alternate use of the rod and casing handler 10, a smaller diameter pipe may be grasped by the clamp 12 as described above, and then the smaller diameter pipe may be inserted into a larger diameter pipe. Another clamp 12 then closes around the larger diameter pipe with the larger diameter pipe seated on arcuate gripping surfaces of the inner tongs 65. In this manner, two pipes are handled by the same rod and casing handler 10 simultaneously.

As described herein with respect to FIG. 1, the rod/pipe 80 inserted in the casing 82 are held in a concentric and coaxial alignment with respect to each other. In addition, the outer and inner tongs 64 and 65, shown in FIG. 2 as an example, hold the rod 80 and the casing 82 securely against the respective gripping surfaces of the outer and inner tongs 64 and 65. The contact between the outer and inner tongs 64 and 65 and a portion of a diameter of the outer cylindrical surface holds the cylindrical bodies such that they do not substantially rotate when engaged by the outer and inner tongs 64 and 65. This prevents or substantially reduces certain rods and casings rotating substantially when gripped by the scissor clamp 12 disclosed herein.

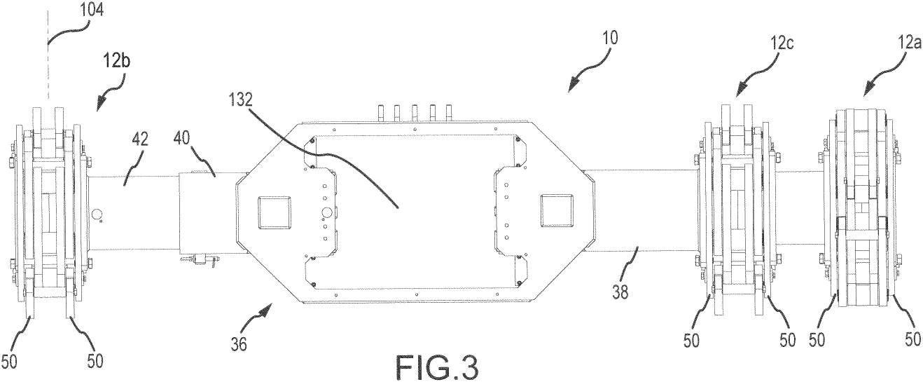

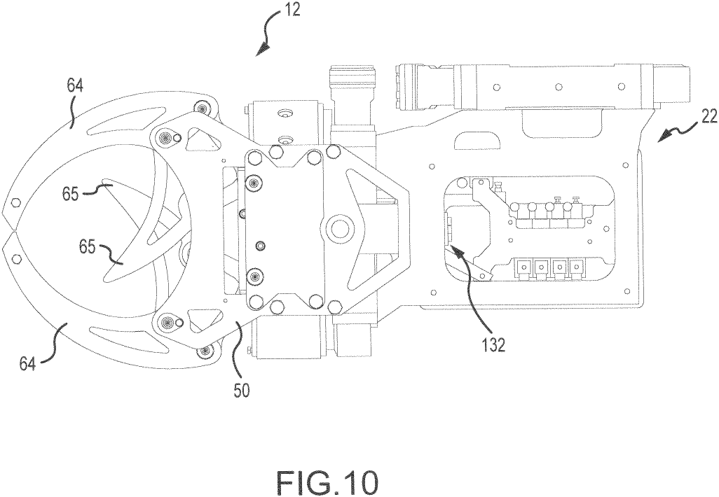

Generally, FIGS. 1-10 illustrate the rod and casing handler 10 including the clamps 12 having the distance between the inner surfaces 110 of the outer tongs 64; although, it should be understood that the outer tongs 64 may have no distance between them. In some embodiments integrally formed outer tongs 64 may be employed such that the central plane 104 may pass through the integrally formed outer tongs 64. FIGS. 1-10 illustrate the rod and casing handler 10 including the clamps 12 having the distance between the inner surfaces of the inner tongs 65; although, it should be understood that the inner tongs 65 may have no distance between them. In some embodiments integrally formed inner tongs 65 may be employed such that the central plane 104 may pass through the integrally formed inner tongs 65.

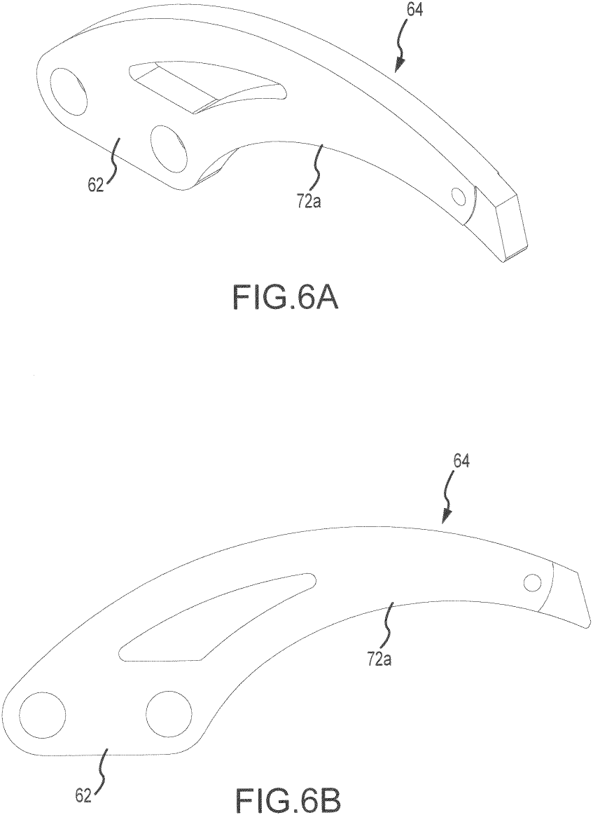

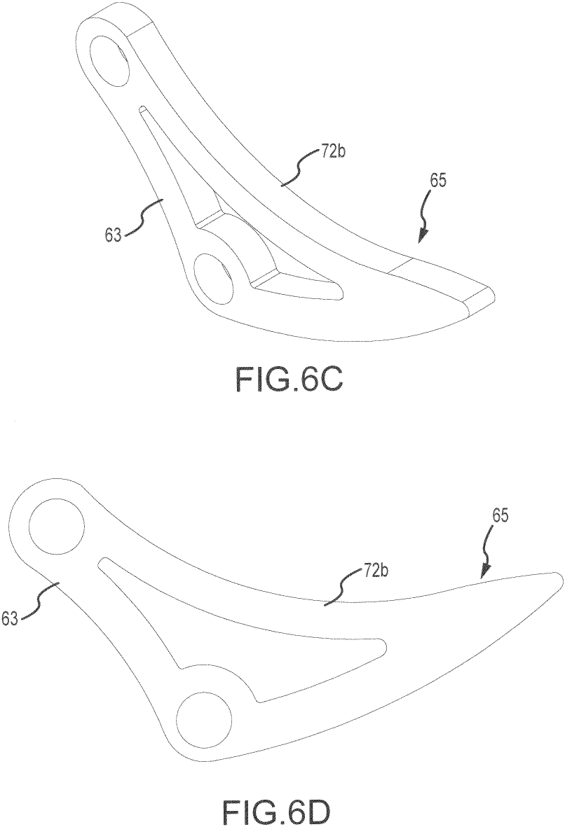

Reference is now made to FIGS. 6A-6D, which are perspective and side views of the outer and inner tongs. Each outer and inner tong 64 and 65 includes an arm portion 62 and 63, respectively, as well as an arcuate surface 72a and 72b, respectively. The outer and inner tongs 64 and 65 as well as a stroke of the cylinder 52 maintain a substantial cylindrical concentricity throughout the entire clamping motion. The shape of the arcuate surfaces 72a and 72b are formed such that projections orthogonal to the surfaces gripping a cylindrical object (such surfaces are disposed inside each outer and inner tongs 64, 65) form substantially equidistant segments that intersect at a point that coincides with a center of a circle which circumference comes into in contact with the gripping surfaces of the outer and inner tongs 64 and 65. There is a need for a substantially precise tolerance of machining of the various components comprising the clamps 12. For example, the arcuate surfaces 72a and 72b may have the tolerance in a range between 0.001 and 0.010 inches. In some embodiments, such tolerance may be, for example, 0.005 inches.

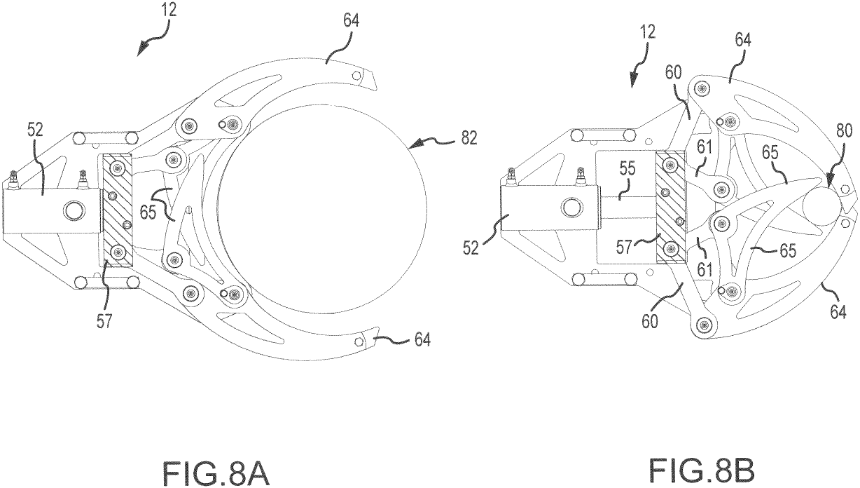

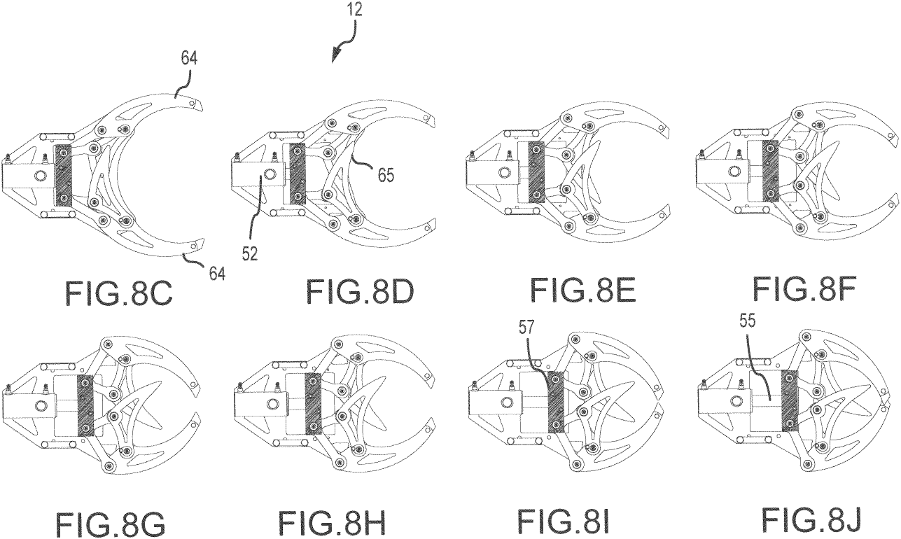

Reference is now made to FIGS. 8A - 8J that illustrate side views of the clamp 12 at varying clamping positions. As illustrated, for example, in FIGS. 8A and 8B, a stroke of the cylinder 52 and the coupled piston 55 may have a range between zero (0) inches/cm (FIG. 8A, corresponding to the outer diameter of the pipe slightly exceeding 50.80 cm (20 inches)) and 13.335 cm (5.25 inches) (FIG. 8B, corresponding to the outer diameter of the pipe equal to 9.378 cm (3.692 inches)). In FIG. 8A, the clamp 12 is illustrated in an open position where the outer tongs and inner tongs 65 and 64, respectively, are positioned to receive the cylindrical object 82 between the inner and outer tongs 64 and 65. In FIG. 8B, the clamp 12 is illustrated in a closed position where the outer tongs and inner tongs 64 and 65, respectively, are positioned to secure the cylindrical object 80 between the inner and outer tongs 64 and 65, respectively, to facilitate handling of the cylindrical object by the handler. The arcuate surfaces 72a and 72b are sized and shaped to correspond to a range of diameters of cylindrical bodies. For example, the arcuate surfaces 72a and 72b of the outer and inner tongs 64 and 65 are sized to correspond to a cylindrical object with a maximum diameter of, for example, approximately 50.80 cm (20 inches) that may be a segment of a casing. For smaller diameter cylindrical bodies, such as a rod and/or smaller pipe, the same arcuate surfaces 72a and 72b of the same outer and inner tongs 64 and 65 referenced above may also be used because, when the tongs 64 and 65 are actuated by the piston 55, they are moved into a position to correspond to cylindrical bodies with a smaller diameter. For example, rods and/or smaller pipes handled by the outer and inner tongs 64 and 65 may have a minimum outer diameter of approximately 9.378 cm (3.692 inches).

Regardless of the size of the gripped pipe suitable for the clamp 12, the center point W stays in a substantially same location when the clamps 12 perform their entire range of motions. In some embodiments, for different sizes of the pipes handled by the clamps 12, the distance is substantially equal between the center point W and projection of any point of the mounting plate 50 on the central plane 104 of the clamp 12 (for example a point, generally denoted as point J in FIGS. 9A and 9B, at which the central axis 120 between two side support brackets 56 supporting the cylinder 52 is projected on the central plane 104, and that forms a distance 170 between the points W and J). In some embodiments, substantially equidistant segments can be between the center point W and any other point on the mounting plate 50 or any other component of the rod and casing handler 10 if such component replicates the movement of the central plane 104 of the clamp 12.

In some embodiments, as illustrated in FIGS. 9A-9B, distances 160a and 160b are segments of projections orthogonal to the surfaces gripping a cylindrical object (such gripping surfaces are disposed inside each outer tong 64). The distances 160a and 160b intersect at the point W that coincides with a center of a pipe (for example, the casing 82), which circumference comes in contact with the gripping surfaces of the outer tongs 64. Distances 160c and 160d are segments of projections orthogonal to the surfaces gripping a cylindrical object (such surfaces are disposed inside each inner tongs 65). The distances 160c and 160d intersect at the point W that coincides with a center of a pipe (for example, the rod 80), which circumference comes in contact with the gripping surfaces of the inner tongs 65. FIGS. 9A-9B illustrate the clamp 12 having the distances 160 a and 160 c forming an angle not substantially equal 180 degrees, the distances 160 b and 160 d forming an angle not substantially equal 180 degrees. Such angles deviating from 180 degrees facilitate a more secure handling of the cylindrical object because there are more than two points of contacts of the gripping surfaces (for example, three or four points of contacts) with the cylindrical object. Such number of contact points greater than two facilitates the clamp 12 to continue the clamping motion and not to stop prematurely when grabbing or otherwise handling the cylindrical object.

In some embodiments, it is preferable to have all points of contact not to be on the same side relative to a line crossing the center point W in a plane substantially parallel to the central plane 104. For example, the rod and casing handler 10 may have the clamps 12 that can handle relatively greater diameters of cylindrical objects. In such cases, to facilitate the better gripping and to avoid or substantially reduce the cylindrical object escaping from outer and inner tongs 64 and 65, at least one point of contact should be on the other side (with respect to the line crossing the center point W) from the other points of contact (as illustrated in FIGS. 9A-9B). If all points of contact are on the same side from the line crossing the center point W, the cylindrical object may fall out from the outer and inner tongs 64 and 65.

In some embodiments, having the outer and inner tongs 64 and 65 that can accommodate different sizes of the pipes that preserve concentricity and/or coaxial location of various pipes allows an operator to perform handling operations more efficiently as compared to the typical rod and casing handlers that, for example, use saddles that are disposed within the clamp 12 instead of the inner tongs 65. The substantially constant equidistance 160 between the center point W and the gripping surfaces of outer and inner tongs 64 and 65 accommodates the different sized diameter pipes and casings and ensures that a rod is maintained in a coaxial alignment in a casing when the casing is gripped by at least one clamp 12 and the rod is gripped by another clamp 12 at the opposite end of the clamp mount assembly 34. This coaxial and/or concentric arrangement of two cylindrical bodies with different diameters allows drill pipes and casings to be efficiently added or removed at a drill site.

As described above, in some embodiments, one size outer tongs 64 and one size inner tongs 65 may be used for handling multiple pipes of different sizes. For example, the appropriately sized outer and inner tongs 64 and 65 may be sized and/or shaped to correspond to the cylindrical bodies, such as pipes, that have an outer diameter of 8.89 cm (3.5 inches) and 50.80 cm (20 inches), or in a range therebetween. The rod and casing handler 10 and the various sized and shaped outer and inner tongs 64 and 65 are configured to handle smaller diameter rods having, for example, an outer diameter of 8.89 cm (3.5 inches) up to larger diameter casings having, for example, an outer diameter of approximately 50.80 cm (20 inches). The rods and casings may have different lengths of, for example, 1.829 meters (6 feet) and 6.096 meters (20 feet), or in a range therebetween. In some embodiments, the rods may be threaded.

For example, FIG. 1 illustrates a perspective view of the rod and casing handler 10 simultaneously handling a pair of the cylindrical bodies, for example the rod 80 and the casing 82. As illustrated, the single rod and casing handler 10 may be used in one instance to handle and grip cylindrical bodies of one size (for example, the rod 80), and the same rod and casing handler 10 may be used to handle cylindrical bodies of a different size (for example, the casing 82), either sequentially or simultaneously.

As shown in FIG. 1, the clamp(s) 12 a, 12 b, and 12 c are disposed at the first arm 38 and/or the adjustable clamp mounting arm 42 coupled to the second arm 40. For example, the clamps 12 b and 12 c may be configured to handle the casings 82 with a relatively larger diameter. In some embodiments, the clamp 12c is disposed at the first arm 38 and clamp 12 b is disposed at the adjustable clamp mounting arm 42 coupled to the second arm 40. In some embodiments, the clamp 12 a is sized and/or shaped to correspond to a smaller diameter cylindrical object, such as the rod 80. In some embodiments, the smaller diameter rod 80 (that is handled by the clamp 12 a configured to a smaller diameter) can be simultaneously handled with handling of the casing 82 (handled by the clamps 12 b and 12 c, each configured to a larger diameter pipe). Therefore, the clamp 12 a of the smaller diameter configuration and the clamps 12 b and 12 c of the larger diameter configuration are capable to center two rods of the same or different diameters. The concentric and/or coaxial alignment of the pipes allows, for example, hollow cylindrical objects to be stacked inside one another while being handled by the rod and casing handler 10.

According to one embodiment, one or more mounting plates 50 of the clamp 12 can be colored differently, for example yellow, to allow the operator to easily distinguish the clamp 12 a handling the smaller diameter of the pipe from the clamps 12 b and 12 c handling the larger diameter of the pipe from, for example, an operator’s position in the cabin of the excavator.

Due to the described herein self-centering feature of the clamp 12, a cylindrical object does not need to be placed in a specific location inside the outer and inner tongs 64 and 65 of the clamp 12 in order to be properly grasped. The cylindrical object can be placed anywhere inside the outer and inner tongs 64 and 65 and can be pulled into the space between the outer and inner tongs 64 and 65 to be properly gripped and secured by the outer and inner tongs 64 and 65. Such self-centering feature of the clamp 12 along with having relatively long outer tongs 64 allows the clamp 12 to more effectively grasp a single cylindrical object that can be separated more effectively from within a stack in which other cylindrical objects are disposed.

For example, a pallet of casings having several sizes of pipes may be handled by the same rod and casing handler 10 with the same outer and inner tongs 64 and 65. As compared to the range of sizes handled by the rod and casing handlers having the saddles instead of the inner tongs 65, there is no need, for example to remove and replace the saddle plates and/or tongs to accommodate a concentric and/or coaxial displacement of a wider range of diameters of the cylindrical objects. The same rod and casing handler 10 may separate a desired cylindrical object from a pallet of pipes having a smaller diameter than the casings, such as, for example, rods. Substantial reduction of the set-up time for removal and replacement of the saddle plates and/or the outer and inner tongs 64 and 65 may thus be achieved.

While the embodiments described above illustrate the clamps 12 not having the saddle plates, it should be understood that, additionally or alternatively, the saddle plates may be utilized too. For example, the saddle plates may be used to achieve a substantial concentricity of the cylindrical objects, where one or more of these objects have a diameter less than the diameter of the cylindrical object that can be securely grasped by the clamp 12 without the saddle plate. For example, the saddle plates may be used if the inner tongs 65 and outer tongs 64 cannot fully grasp the smaller diameter pipe to have at least three points of contact in a plane parallel to the central plane 104 of the clamp 12. For example, if the diameter of the cylindrical object is less than 3.692 inches, the saddle plate can be used to hold the cylindrical object securely against the outer tongs 64.

According to some embodiments, the outer and inner tongs 64 and 65 are removable and replaceable to facilitate handling of a different range of diameters of the cylindrical bodies. For example, longer tongs may be attached to handle larger diameter cylindrical bodies. A supplier may offer a set of outer and inner tongs 64 and 65 that are sized to handle the cylindrical bodies with a particular diameter range.

In operation, the outer tongs 64 of the clamp 12 may be open such that the clamp 12 may be lowered onto a pipe, rod, and/or casing. In some embodiments, the arcuate surfaces 72 b of the inner tongs 65 engage the outer surface of the pipe, rod, and/or casing. The arcuate surfaces 72 a of the outer tongs 64 are closed by the operator and they grasp the side of the pipe opposite the side of the pipe that is in contact with the arcuate surfaces 72 b of the inner tongs 65. With the outer and inner tongs 64, 65 closed around the pipe, the rod and casing handler 10 may be lifted away from the pile and/or stack of the pipes. Thus, a single clamp 12 can grasp a single pipe.

Although preferred embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments and it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A handler for handling a cylindrical object having a central axis, the handler having at least one clamp, the clamp comprising:
a mounting plate;
a piston assembly coupled to the mounting plate;
a central plane of the clamp, the central plane oriented substantially orthogonal to a central axis of the cylindrical object;
a plurality of outer tongs and inner tongs pivotally coupled to the mounting plate, the outer tongs including first pairs of outer tongs spaced apart on separate sides of the central plane, the inner tongs including second pairs of inner tongs spaced apart on the separate sides of the central plane;
a plurality of linkage bars pivotally coupled between the piston assembly and the plurality of outer tongs and inner tongs; and
wherein, in response to a movement of the piston assembly, the inner and outer tongs pivot between an open position, to receive the cylindrical object between the inner and outer tongs, and a closed position, to secure the cylindrical object between the inner and outer tongs to facilitate handling of the cylindrical object by the handler.

2. The handler of claim 1,
wherein a distance between the spaced apart pairs of outer tongs is at least 2 inches.

3. The handler of claim 1, wherein a bushing is disposed between the spaced part pairs of outer tongs.

4. The handler of claim 1,
wherein the clamp is configured to handle a pipe having a length in a range between 6 and 20 feet.

5. The handler of claim 1, wherein the clamp is configured to be positioned in the closed position, the clamp further comprises:
a center point coaxial with a projection of a central longitudinal axis of a grasped cylindrical object in the closed position of the clamp,
wherein segments of projections intersecting at the center point and orthogonal to contact surfaces of the outer and inner tongs grasping the cylindrical object are substantially equidistant.

6. The handler of claim 1, wherein the clamp positioned in the closed position, the clamp further comprises:
a center point coaxial with a projection of a central longitudinal axis of a grasped cylindrical object in the closed position of the clamp,
wherein segments of projections intersecting at the center point and orthogonal to contact surfaces of the outer and inner tongs gripping the cylindrical object form angles between the segments that are not substantially equal to 180 degrees.

7. The handler of claim 1,
wherein the clamp is configured to handle the cylindrical object having an outer diameter in a range between 3.692 inches and 20 inches.

8. The handler of claim 1, wherein the outer and inner tongs of the clamp further comprise arcuate surfaces for grasping an object.

9. A handler for handling cylindrical objects having central axes, the handler having a plurality of clamps, the each clamp comprising:
a mounting plate;
a piston assembly coupled to the mounting plate;
a central plane of the clamp substantially orthogonal to the central axes of the cylindrical objects;
a plurality of outer tongs and inner tongs pivotally coupled to the mounting plate, the outer tongs including first pairs of outer tongs spaced apart on separate sides of the central plane, the inner tongs including second pairs of inner tongs spaced apart on the separate sides of the central plane; and
a plurality of linkage bars pivotally coupled between the piston assembly and the plurality of outer tongs and inner tongs;
wherein, in response to a movement of the piston assembly of a first clamp, the inner and outer tongs of the first clamp pivot between an open position and a closed position of the first clamp and wherein, in response to a movement of the piston assembly of a second clamp, the inner and outer tongs of the second clamp pivot between an open position and a closed position of the second clamp, such that the first and second clamps simultaneously and concentrically handle the first cylindrical object having a first diameter and the second cylindrical object having a second diameter.

10. The handler of claim 9,
wherein a distance between the spaced apart pairs of outer tongs is at least 2 inches.

11. The handler of claim 10, further comprising a bushing extending between the spaced apart pairs of outer tongs.

12. The handler of claim 9,
wherein the clamp is configured to handle a pipe having a length in a range between 6 and 20 feet.

13. The handler of claim 9, wherein the clamp positioned in the closed position, the clamp further comprising:
a center point coaxial with a projection of a central longitudinal axis of a grasped cylindrical object in the closed position of the clamp,
wherein segments of projections intersecting at the center point and orthogonal to contact surfaces of the outer and inner tongs grasping the cylindrical object are substantially equidistant.

14. The handler of claim 9, wherein the clamp positioned in the closed position, the clamp further comprising:
a center point coaxial with a projection of a central longitudinal axis of a grasped cylindrical object in the closed position of the clamp,
wherein segments of projections intersecting at the center point and orthogonal to contact surfaces of the outer and inner tongs gripping the cylindrical object form angles between the segments that are not substantially equal to 180 degrees.

15. The handler of claim 9,
wherein the clamp is configured to handle the cylindrical object having an outer diameter in a range between 3.692 inches and 20 inches.

16. The handler of claim 9, wherein the outer and inner tongs of the clamp further comprise arcuate surfaces for grasping an object and wherein a tolerance for machining the arcuate surfaces is in a range between 0.001 and 0.010 inches.

17. A handler for handling cylindrical objects having central axes, the handler having at least two arms and a plurality of clamps, wherein at least one clamp is disposed on each arm, each clamp comprising:
a mounting plate;
a piston assembly coupled to the mounting plate;
a central plane of the clamp substantially parallel to the mounting plate and substantially orthogonal to the central axes of the cylindrical objects;
a plurality of outer tongs and inner tongs pivotally coupled to the mounting plate, the outer tongs including first pairs of outer tongs spaced apart on separate sides of the central plane, the inner tongs including second pairs of inner tongs spaced apart on the separate sides of the central plane; and
a plurality of linkage bars pivotally coupled between the piston assembly and the plurality of outer tongs and inner tongs;
wherein, in response to a movement of the piston assembly of the each clamp, the inner and outer tongs of the each clamp pivot between an open position and a closed position of the each clamp.

18. The handler of claim 17,
wherein at least one arm of the handler is extendable to facilitate handling of longer cylindrical objects.

19. The handler of claim 17,
wherein each of a first arm and a second arm includes the at least one clamp and wherein the clamp of the first arm is configured to handle cylindrical objects synchronously with the clamp of the second arm.

20. The handler of claim 17,
wherein at least a first clamp on a first arm is configured to handle cylindrical objects independently from a second clamp on a second arm.
